(19) United States
(12) Patent Application Publication
(10) Pub. No.: US 2006/0219636 A1
(43) Pub. Date: Oct. 5, 2006

(54) Siloxane-immobilized particulate stationary phases for chromatographic separations and extractions

(75) Inventors: Robert Plumb, Milford, MA (US); Jennifer H. Granger, Northborough, MA (US)

Correspondence Address: EDWARDS & ANGELL, LLP, P.O. BOX 55874, BOSTON, MA, 02205, US

(73) Assignee: Waters Investments Limited, New Castle (DE)

(21) Appl. No.: 10/545,331

(22) PCT Filed: Feb. 10, 2004
(86) PCT No.: PCT/US04/03932

§ 371 Date: Jan. 3, 2006

Related U.S. Application Data
(60) Provisional application No. 60/446,457, filed on Feb. 10, 2003.

(51) Int. Cl. B01D 15/08

(52) U.S. Cl. 210/656; 210/198.2; 210/502.1; 422/70

(57) ABSTRACT

Chromatography and solid phase extraction devices having immobilized stationary phases are disclosed. An exemplary device of the Invention includes a column or cartridge packed with a mixture of a particulate stationary phase material and a polymeric network of Cross-linked poly(diorganosiloxane), e.g., poly(dimethylsiloxane). The Invention also provides methods of making and using such devices.

### RELATED APPLICATIONS

This application is a U.S. national phase application, pursuant to 35 U.S.C. §371, of PCT international application Ser. No. PCT/US2004/003932 filed Feb. 10, 2004, designating the United States, which claims priority under 35 U.S.C. § 119 to U.S. Provisional patent application Ser No. 60/446,457 filed Feb. 10, 2003. The entire contents of the aforementioned patent applications are incorporated herein by this reference.

### BACKGROUND OF THE INVENTION

Several contemporary methods exist for the analytical or preparative separation of components of a mixture. In general, a liquid sample containing compounds of interest is separated by partitioning between a mobile phase and a stationary phase, and the individual separated compounds are analyzed.

Solid phase extraction (“SPE”) is now widely used for pre-concentrating and filtering analytical samples, for purification of various chemicals, and for large-scale applications such as removal of toxic or valuable substances from a variety of predominately aqueous solutions. Typical applications include methods for determination of trace amounts of pesticides, for determination of trace organic contaminants in water, for analysis of industrial waste water, determination of organic pollutants in water and isolation of organic compounds from ground water, sampling of priority pollutants in waste water, collection and concentration of environmental samples, and for pretreatment of urine or other medical samples. Solid phase extraction is a technique that employs a flow-through chamber containing a an extraction material, which is almost commonly a stationary phase material for use in chromatographic separations. Typically, a liquid sample containing analytes of interest is flushed through a cartridge or other container holding the stationary phase material, and the analytes of interest are retained on the material. A small amount of a solvent having a high solubility factor for the analytes of interest is then flushed through the cartridge, thereby dissolving and carrying away the components for analysis. For example, a common sample is an aqueous solution (e.g., blood or plasma samples, ecological or environmental water samples, industrial effluent samples), in which case a suitable stationary phase material may be a reversed-phase stationary phase material (e.g., C₁₈-bonded silica) and a suitable solvent may be acetonitile, methanol acetone, ethyl acetate, and so on. In this manner, the analytes in a large liquid sample may be concentrated into a smaller volume, and therefore the sensitivity of a subsequent analysis is usually greater because the concentration of the analytes is higher. SPE devices are available in a variety of different formats. One common format is a small column or cartridge containing an appropriate resin. Membranes impregnated with appropriate resins have also been used for solid phase extraction. When carried out on a small scale, this technique may be referred to as solid phase micro-extraction (“SPME”).

High performance liquid chromatography (“HPLC”) is a common analytical method that employs partitioning between a mobile liquid phase under high pressure and a stationary phase, for example silica-based columns, including bonded silica, and organic resins such as divinyl benzene. Of these, reverse phase silica-based columns are preferred because they have high separation efficiencies, are mechanically stable, and a variety of functional groups may be easily attached for a variety of column selectivities. Recently, miniature HPLC chromatography systems and techniques have been developed. These techniques use columns of smaller internal diameter than are usually used in conventional HPLC separations, and they only require samples of less than about 1 μL. These techniques are referred to by several names, including “micro liquid chromatography” (or “MLC”), “micro-high-performance LC” or simply “micro LC” “capillary LC,” or “nanoLC” (i.e., the term used herein). U.S. Pat. Nos. 4,102,782 and 4,346,610.

Similar, if not identical stationary phase materials are used in both SPE and liquid chromatography (“LC”) devices, and they are generally classified into two types: organic materials, e.g., polydivinylbenzene, and inorganic materials typified by silica. Many organic materials are chemically stable against strongly alkaline and strongly acidic mobile phases, allowing flexibility in the choice of mobile phase pH. However, organic chromatographic materials generally result in columns with low efficiency, leading to inadequate separation performance, particularly with low molecular-weight analytes. Furthermore, many organic chromatographic materials shrink and swell when the composition of the mobile phase is changed. In addition, most organic chromatographic materials do not have the mechanical strength of typical chromatographic silicas. Due in large part to these limitations, silica is the material most widely used in HPLC. The most common applications employ silica that has been surface-derivatized with an organic group such as octadecyl (C₁₈), octyl (C₈), phenyl, amino, cyano, etc. As stationary phases for HPLC, these packing materials result in columns that have high efficiency and do not show evidence of shrinking or swelling.

A further problem associated with silica particles and polymer particles is packed bed stability. Chromatography columns packed with spherical particles may be considered to be random close packed lattices in which the interstices between the particles form a continuous network from the column inlet to the column outlet. This network forms the interstitial volume of the packed bed which acts as a conduit for fluid to flow through the packed column. In order to achieve maximum packed bed stability, the particles must be tightly packed, and hence, the interstitial volume is limited in the column. As a result, such tightly packed columns afford high column backpressures which are not desirable. Moreover, bed stability problems for these chromatography columns are still typically observed, because of particle rearrangements. Two common strategies for stabilizing a packed bed made of loose stationary phase material are retention of the bed within solid supports, typically a frit, or immobilization of the entire packed bed itself.

In an attempt to overcome the problem of packed bed stability, several groups have reported studies on stabilizing the packed bed by sintering or interconnecting inorganic, e.g., silica based particles. In the sintering process, particles are joined to one another by grain boundaries. In one approach, previously prepared octadecylsilica particles are immobilized in a sol-gel matrix or a polymer matrix prepared in situ in a chromatography column. In another approach, agglomeration of the silica based C-18 particles at high temperature has been reported (M. T. Dulay, R. P. Kulkarm, R. N. Zare, Anal. Chem., 70 (1998) 5103; Xin, B.; Lee, M. L. Electrophoresis 1999, 20, 67; Q. Tang, B. Xin, M. L. Lee, J. Chromatogr. A, 837 (1999) 35.; Q. Tang, N. Wu, M A L. Lee, J. Microcolumn Separations, 12 (2000) 6.; R. Asiaie, X. Huang, D. Faman, Cs. Horvath, J. Chromatogr. A, 806(1998)251). In addition, interconnection of silica particles surface modified by Al chelate compounds (S. Ueno, K Muraoka, H. Yoshimatsu, A. Osaka, Y Miura, Journal-Ceramic Society Japan, 109 (2001) 210.) and microwave sintering of silica particles (A. Goldstein, R. Ruginets, Y. Geffen, J. of Mat. Sci. Letters, 16 (1997) 310) have been reported. The interstitial porosity of the above particle-sintered or interconnected columns, and hence the permeability of the columns obtained by this approach is less than or similar to those of the conventional packed columns. Therefore, the backpressures of the column are the same or higher than those of the conventional packed columns, and result in an inability to achieve high efficiency chromatographic separations at low backpressures and high flow rates.

In another attempt to overcome the combined problems of packed bed stability and high efficiency separations at low backpressures and high flow rates, several groups have reported the use of monolith materials in chromatogaphic separations. Monolith materials are characterized by a continuous, interconnected pore structure of large macropores, the size of which may be changed independent of the skeleton size without causing bed instability. The large macropores allow liquid to flow directly through with very little resistance resulting in very low backpressures, even at high flow rates. However there are several critical drawbacks associated with existing monolith materials. Columns made using organic monolith materials, e.g., polydivinylbenzene, generally have low efficiency, particularly for low molecular weight analytes. Although organic monoliths are chemically stable against strongly alkaline and strongly acidic mobile phases, they are limited in the composition of organic solvent in the mobile phase due to shrinking or swelling of the organic polymer, which may negatively affect the performance of these monolithic columns. For example, as a result of monolith shrinking, the monolith may lose contact with the wall and thus allow the eluent to by-pass the bed, whereupon chromatographic resolution is dramatically decreased. Despite the fact that organic polymeric monoliths of many different compositions and processes have been explored, no solutions have been found to these problems. In addition, chromatographic columns have also been made from inorganic monolith materials, e.g., silica. Inorganic silica monoliths do not show evidence of shrinking and swelling, and exhibit higher efficiencies than their organic polymeric counterparts in chromatographic separations. However, silica monoliths suffer from the same major disadvantages described previously for silica particles: residual silanol groups after surface derivatization create problems that include increased retention, excessive tailing, irreversible adsorption of some analytes, and the dissolution of silica at alkaline pH values. In fact, as the variation of the pH is one of the most powerful tools in the manipulation of chromatographic selectivity, there is a need to expand the use of chromatographic separations into the alkaline pH range for monolith materials, without sacrificing analyte efficiency, retention and capacity.

The chromatography columns used in analytical methods (e.g., HPLC and nanoLC) and extraction methods (SPE) require for optimal performance a permeable containment devices to retain fluids or stationary phase material within a column, or to filter particles, e.g., particulate contaminants in analytical samples. Common containment devices include fiberglass packings, screens, and bonded particles, typically referred to as “frits.”

One alternative to the use of flits for immobilizing stationary phase materials in SPE devices is impregnation of particles of the material in a permeable membrane, typically a poly(tetrafluoroethylene) membrane. Such membranes are expensive and may lead to sample contamination if components of the polymer are released into the concentrated extract, particularly if the membrane is accidentally allowed to dry during the extraction procedure.

There are many different methods of making frits but most techniques employ the consolidation of small particles by sintering or melting compressed particles of a known size together. In one typical method, an appropriate material is ground up into small pieces and screened for a selected size range of particles. The particles are then compressed together in a mold and heated to fuse the particles together, but not to melt or degrade the particles. After heating, the material is further processed by machining, and welding or gluing to an appropriate substrate. Another approach uses filaments, of either metals and plastics, that are randomly arranged, compressed, and fused together. Such filamentous frits are generally only appropriate for large (i.e., non-capillary) columns. Yet another approach uses screens to provide a containment device that serves as an alternate to frits, but screens generally have a lower limit of performance based on the size of the wire or filament used. However, screens offer low back pressure compared to frits. Colon, et al., J. Chromatog. 887, 43 (2000).

Neither the flit nor the screen offers an ideal structure for the containment of a packing or for providing a particle filter in applications that require small hole or pore sizes, particularly for a packed capillary column as used in either liquid chromatography or SPE. The conventional frit, because of the convoluted route of the pore including paths that contain lateral translations, has high back pressure. While a screen has low back pressure, the screen has a lower limit on pore size. Frits also cause a void volume that reduces the quality of chromatographic data, especially in smaller columns and in separations of small volumes in which the volume of the frit relative to the sample volume is considerable. See also, Chen, Anal. Chem. 72, 1224 (2000); Zeng, Sens Actuators B 82, 209 (2002); Chen, Anal. Chem. 73, 1987 (2001); Chirica, Anal. Chem. 72, B605 (2000); Kato, J. Chem. A 924, 187 (2001); Colon, J. Chem. A 887, 42 (2000); Duley, Anal. Chem. 73, 3291 (2001); Chirica, Electrophoresis 21, 3093 (2000); Moris, Science 284, 622 (1999); Leonard, J. Chrom. B. 6664, 37 (1995); Yang, J. Chrom. 544, 233 (1991); U.S. Pat. No. 6,048,457.

### SUMMARY OF THE INVENTION

The present invention provides methods and materials that address the shortcomings described above. In particular, the present invention provides chromatography and solid phase extraction devices having immobilized stationary phases. An exemplary device of the invention includes a column or cartridge packed with a mixture of a particulate stationary phase material and a polymeric network of cross-linked poly(diorganosiloxane), e.g., poly(dimethylsiloxane). The invention also provides methods of making and using such devices.

The present invention also provides for “fritless” SPE devices, especially microscale SPE devices. An SPE device that does not require a frit to immobilize the stationary phase bed within has a lower void volume and therefore may be advantageously used in small scale extractions, e.g., in extractions yielding μL-scale concentrated solutions. The immobilized stationary phases of the invention are more stable than the corresponding stationary phases, and therefore they may also be used in SPE devices containing flits where such stability is desired. High bed stability may be desired to minimize the risk of corrupting packed beds during transportation or shipping from a manufacturing facility to a consumer for ultimate use. Likewise, high bed stability enables field use of SPE devices especially in physically demanding environments which would otherwise preclude on-the-spot sample preparation using conventional devices. For similar reasons, the greater bed stability of the stationary phases of the invention may also be advantageously exploited in typical liquid chromatography, such as HPLC.

The instant invention relates to an immobilized a stationary phase in a chromatography column comprising an intimate mixture of particles comprising a stationary phase material and a polymeric network comprising cross-linked poly(diorganosiloxane), wherein said particles are suspended in said network.

In another embodiment, the invention relates to a medium for molecular separations or extractions comprising an intimate mixture of particles comprising a stationary phase material and a polymeric network comprising cross-linked poly(diorganosiloxane), and wherein said particles are suspended in said network.

The invention also discloses a chromatography device comprising a) a column having a cylindrical interior for accepting a stationary phase; and b) an immobilized particulate stationary phase packed within said column; wherein said immobilized stationary phase comprises an intimate mixture of particles comprising a stationary phase material and a polymeric network comprising cross-linked poly(diorganosiloxane), and wherein said particles are suspended in said network.

Similarly, the invention pertains to a chromatography device prepared by the steps of providing a column having a cylindrical interior for accepting a stationary phase, and forming an immobilized stationary phase within said column, wherein said immobilized stationary phase comprises an intimate mixture of particles comprising a stationary phase material and a polymeric network comprising cross-linked poly(diorganosiloxane), and wherein said particles are suspended in said network.

In another embodiment, the invention is a method of making a chromatography device comprising the steps of a) providing a column having a cylindrical interior for accepting a stationary phase, a stationary phase material, and polymer reagents, and b) forming an immobilized stationary phase within said column; said forming step comprising the steps of i) placing said stationary phase material and said polymer reagents into said column; and ii) curing the product of step (i) within said column to thereby produce an intimate mixture of particles comprising said stationary phase material and, a polymeric network comprising cross-linked poly(diorganosiloxane), and wherein said particles are suspended in said network.

Likewise, the invention includes a method of making a chromatography device comprising the steps of a) providing a mixture of a stationary phase material, a solvent, and polymer reagents that produce cross-linked poly(diorganosiloxane); and a column having a cylindrical interior for accepting a stationary phase; b) introducing said mixture prepared in step (a) into said column; c) allowing the solvent to evaporate at room temperature; and d) curing the dried mixture by heating the column and the mixture therein to a temperature of between about 70° C. to about 150° C. for a period of time ranging from about 0.5 hours to about 3 hours to thereby produce an immobilized stationary phase consisting of an intimate mixture of particles comprising said stationary phase material and a polymeric network comprising cross-linked poly(diorganosiloxane), and wherein said particles are suspended in said network. The step of forming a stationary phase may comprise the steps of a) preparing a mixture of said stationary phase material, a solvent, and synthetic precursors of cross-linked poly(diorganosiloxane); b) introducing said mixture prepared in step (a) into an end of said column; c) allowing the solvent to evaporate at room temperature; and d) curing the dried mixture by heating the column and the mixture therein to a temperature of between about 70° C. to about 150° C. for a period of time ranging from about 0.5 hours to about 3 hours to thereby produce an in situ frit.

Also, the invention includes a separations instrument comprising a (i) chromatography device and at least one component selected from a (ii) detecting means, an (iii) introducing means, or an (iv) accepting means, wherein (i) said chromatography device comprises a) a column having a cylindrical interior for accepting a stationary phase, and b) an immobilized stationary phase within said column comprising an intimate mixture of particles of a stationary phase material and a polymeric network of cross-linked poly(diorganosiloxane), and wherein said particles are suspended in said network; (ii) said detecting means is operatively connected to said column and is capable of measuring physicochemical properties; and (iii) said introducing means is operatively connected to said column and is capable of conducting a liquid into said column; and (iv) said accepting means is capable of holding said column in a configuration in which the column is operatively connected to either a detecting means or an introducing means.

In like manner, the invention includes a separations instrument comprising a column chromatography device comprising a) a column having a cylindrical interior for accepting a stationary phase; b) an immobilized stationary phase within said column, wherein said immobilized stationary phase comprises an intimate mixture of particles comprising a stationary phase material and a polymeric network comprising cross-linked poly(diorganosiloxane), and wherein said particles are suspended in said network. For example, the instrument may be a HPLC instrument. The instrument may comprise a pumping means for moving liquid through said column chromatography device, and a detecting means for analyzing the column chromatography device effluent.

The invention also includes an analytical method of separating components of a mixture comprising a step of contacting said mixture with a column chromatography device comprising a) a column having a cylindrical interior for accepting a stationary phase; and c) an immobilized stationary phase within said column, wherein said immobilized stationary phase comprises an intimate mixture of particles comprising a stationary phase material and a polymeric network comprising cross-linked poly(diorganosiloxane), and wherein said particles are suspended in said network.

In another embodiment, the invention is a method of analyzing components of a mixture comprising a step of contacting said mixture with a chromatography device according to claim 3, wherein said chromatography device is an HPLC column.

In another embodiment, the invention includes a method of separating components of a mixture comprising a step of contacting said mixture with a chromatography device according to claim 3, wherein said chromatography device is an HPLC column.

In yet another embodiment, the invention is a method of extracting components of a mixture comprising a step of contacting said mixture with a chromatography device according to claim 3, wherein said chromatography device is an SPE device.

In another related embodiment, the invention is a method of concentrating components of a mixture comprising a step of contacting said mixture with a chromatography device according to claim 3, wherein said chromatography device is an SPE device.

In another embodiment, the invention is a fritless chromatography device comprising a column and an immobilized stationary phase therein, wherein said immobilized stationary phase is an intimate mixture of particles comprising a stationary phase material and a polymeric network comprising cross-linked poly(diorganosiloxane), wherein said particles are suspended in said network.

In another related embodiment, the invention is a fritless chromatography device prepared by the steps of a) providing a column having a cylindrical interior for accepting a stationary phase; b) placing a particulate stationary phase material into said column; c) introducing polymer reagents into said stationary phase throughout said column to thereby form a mixture, wherein said polymer reagents are capable of forming a by cross-linking reactions a polymeric network of poly(diorganosiloxane); and d) curing the mixture to thereby cross-link said poly(diorganosiloxane).

Additionally, the invention is a fritless chromatography device prepared by the steps of a) providing a column having a cylindrical interior for accepting a stationary phase; b) placing a mixture of particulate stationary phase material and polymer reagents into said column, wherein said polymer reagents are capable of forming by cross-linking reactions a polymeric network of poly(diorganosiloxane); and c) curing the mixture to thereby cross-link said poly(diorganosiloxane).

Furthermore, in another embodiment, the invention pertains to a method of making a packed HPLC column comprising the steps of a) providing a stainless steel column having a cylindrical interior for accepting a stationary phase; b) placing a mixture of particulate stationary phase material, a compatible solvent, and polymer reagents into said stainless steel wherein said polymer reagents are capable of forming by cross-linking reactions a polymeric network of poly(diorganosiloxane); c) applying high pressure to compress or pack said mixture within said column; and d) curing said mixture within said column while maintaining high pressure to cross-link said poly(diorganosiloxane) and thereby produce an immobilized stationary phase.

In yet another embodiment, the invention is a solid phase extraction apparatus comprising a hollow body having an input port, an output port, and an immobilized a stationary phase located therein, wherein said immobilized stationary phase is an intimate mixture of particles comprising a stationary phase material and a polymeric network comprising cross-linked poly(diorganosiloxane), wherein said particles are suspended in said network.

### DETAILED DESCRIPTION OF THE INVENTION

The present invention will be more fully illustrated by reference to the definitions set forth below.

The terms “chromatographic” or “chromatography” as used herein generally refer both the separation techniques embodied by HPLC and the extraction techniques of SPE, to the extent that these terms relate to the underlying phenomenon of partitioning between stationary and mobile phases.

The term “stationary phase material” or “packing material” means a loose particulate material intended for chromatographic use. Once the material is packed and in contact with the mobile phase, it typically is referred to as the “stationary phase,” i.e., one of the two chromatographic phases. That is, the stationary phase usually consists of a specific stationary phase material, which has been “packed” into a column. Thus, a packed “chromatographic column” may be, e.g., a packed HPLC column or a packed SPE cartridge.

The expression “chromatographic bed,” “packed bed,” or simply “bed” may be used as a general term to denote any of the different forms in which the stationary phase is used. The stationary phase is the part of a chromatographic system responsible for the retention of the analytes, which are being carried through the system by the mobile phase.

The “packing” is the active solid, stationary phase plus any solid support that is contained in the chromatographic column.

A “solid support” is a solid that holds or retains the stationary phase but typically does not substantially contribute to the separation (or extraction) process. An inlet or outlet frit in a typical liquid chromatography column is an example of a solid support. Therefore, an in situ frit according to the present invention is a solid support, a component of the packing (because it is part stationary phase material), and a component of the stationary phase (at least to the extent that the stationary phase material within the frit contributes to the separation or extraction process.)

An “immobilized stationary phase” or “immobilized bed” is a stationary phase in which the stationary phase material that has been packed in a chromatographic column and has been immobilized, e.g., by either a physical attraction, chemical bonding, or by in situ polymerization of the stationary phase material itself. IUPAC, Pure and Applied Chemistry 69, 1475-1480 (1997).

“Alkyl-bonded” stationary phase or material is a bonded stationary phase (or material) in which the group bound to the surface contains an alkyl chain (usually between C₁ and C₁₈).

“Phenyl-bonded” stationary phase (or material) is a bonded stationary phase (or material) in which the group bound to the surface contains a phenyl group.

“Cyano-bonded” stationary phase (or material) is a bonded stationary phase in which the group bound to the surface contains a cyanoalkyl group (e.g., —(CH₂)ₙ—CN).

“Diol-bonded” stationary phase (or material) is a bonded stationary phase in which the group bound to the surface contains a vicinal dihydroxyalkyl group (e.g., —(CH₂)n—CHOH—CH₂OH).

“Amino-bonded” stationary phase (or material) is a bonded stationary phase in which the group bound to the surface contains an aminoalkyl group (e.g. —(CH₂)ₙ—NH₂).

“Capped” stationary phase (or material) (also known as “end-capped” stationary phase or material) is a bonded stationary phase (or material) that has been treated with a second (usually less bulky) reagent, which is intended to react with remaining functional (e.g., silanol) groups which have not been substituted by the original reagent because of steric hindrance.

The term “monolith” is intended to include a porous, three-dimensional material having a continuous interconnected pore structure in a single piece. A monolith is prepared, for example, by casting precursors into a mold of a desired shape. The term monolith is meant to be distinguished from a collection of individual particles packed into a bed formation, in which the end product comprises immobilized individual particles.

The terms “coalescing” and “coalesced” are intended to describe a monolith material in which several individual components have become coherent to result in one new component by an appropriate chemical or physical process, e.g., heating. A coalesced monolith material is meant to be distinguished from a collection of individual particles in close physical proximity, e.g., in a bed formation, in which the end product, e.g., the bed, comprises immobilized individual particles.

According to at least one embodiment of the present invention, the stationary phase is immobilized in situ by growing or cross-linking a polymeric network around and between individual particles (preferably spherical particles) of stationary phase material to thereby “suspend” the particles in a polymeric network. This type of material is therefore neither a monolith, nor a coalesced material as the terms are used herein As explained in more detail herein, an immobilized stationary phase of the invention may be made my curing a stationary phase material and polymer reagents in a column. The polymer reagents are compounds that produce cross-linked poly(diorganosiloxane) after “curing.” The resulting material within the column is a suspension of discrete particles, which may be visually identified by microscopy, in a polymeric network. As the poly(diorganosiloxane) cures, it reacts with itself and the other polymer reagents to form cross-links which all together form a network or matrix throughout the particulate stationary phase material. Such a mixture is therefore an “intimate” homogenous mixture, as opposed to a simple mixture of two separate components having no interaction with each other. As such, the product is an immobilized stationary phase, rather than a monolith.

“Hybrid,” i.e., as in “porous inorganic/organic hybrid particles” includes inorganic-based structures wherein an organic functionality is integral to both the internal or “skeletal” inorganic structure as well as the hybrid material surface. The inorganic portion of the hybrid material may be, e.g., alumina, silica, titanium or zirconium oxides, or ceramic material; in a preferred embodiment, the inorganic portion of the hybrid material is silica. Hybrid particles are described in WO 00/45951, WO 03/014450 and WO 03/022392.

According to the present invention, the term “aliphatic group” includes organic moieties characterized by straight or branched-chains, typically having between 1 and 22 carbon atoms. In complex structures, the chains may be branched, bridged, or cross-linked. Aliphatic groups include alkyl groups, alkenyl groups, and alkynyl groups.

Alkyl groups include saturated hydrocarbons having one or more carbon atoms, including straight-chain allyl groups (e.g., methyl, ethyl, propyl butyl, pentyl, hexyl, heptyl, octyl, nonyl, decyl, etc.), cyclic alkyl groups (or cycloalkyl or alicyclic groups) (e.g., cyclopropyl cyclopentyl cyclohexyl, cycloheptyl, cyclooctyl, etc.), branched-chain alkyl groups (isopropyl, tert-butyl, sec-butyl, isobutyl, etc.), and alkyl-substituted alkyl groups (e.g., alkyl-substituted cycloalkyl groups and cycloalkyl-substituted alkyl groups).

In certain embodiments, a straight-chain or branched-chain alkyl group may have 30 or fewer carbon atoms in its backbone, e.g. C₁-C₃₀ for straight-chain or C₃-C₃₀ for branched-chain. In certain embodiments, a straight-chain or branched-chain alkyl group may have 20 or fewer carbon atoms in its backbone, e.g., C₁-C₂₀ for straight-chain or C₃-C₂₀ for branched-chain, and more preferably 18 or fewer. Likewise, preferred cycloalkyl groups have from 4-10 carbon atoms in their ring structure, and more preferably have 4-7 carbon atoms in the ring structure. The term “lower alkyl” refers to alkyl groups having from 1 to 6 carbons in the chain, and to cycloalkyl groups having from 3 to 6 carbons in the ring structure,

Unless the number of carbons is otherwise specified, “lower” as in “lower aliphatic,” “lower alkyl,” “lower alkenyl” etc. as used herein means that the moiety has at least one and less than about 8 carbon atoms. In certain embodiments, a straight-chain or branched-chain lower alkyl group has 6 or fewer carbon atoms in its backbone (e.g., C₁-C₆ for straight-chain, C₃-C₆ for branched-chain), and more preferably 4 or fewer. Likewise, preferred cycloalkyl groups have from 3-8 carbon atoms in their ring structure, and more preferably have 5 or 6 carbons in the ring structure. The term “C₁-C₆” includes alkyl groups containing 1 to 6 carbon atoms.

Moreover, unless otherwise specified the term alkyl includes both “unsubstituted alkyls” and “substituted alkyls,” the latter of which refers to alkyl moieties having substituents replacing one or more hydrogens on one or more carbons of the hydrocarbon backbone. Such substituents may include, for example, alkenyl, alkynyl, halogen, hydroxyl, alkylcarbonyloxy, arylcarbonyloxy, alkoxycarbonyloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfates, alkylsulfinyl, sulfonato, sulfamoyl, sulfonamido, nitro, trifluoromethyl, cyano, azido, heterocyclyl alkylaryl, or aromatic or heteroaromatic moieties.

An “arylalkyl” moiety is an alkyl group substituted with an aryl (e.g., phenylmethyl (i.e., benzyl)). An “alkylaryl” moiety is an aryl group substituted with an alkyl group (e.g., p-methylphenyl (i.e., p-tolyl)). The term “n-alkyl” means a straight-chain (i.e., unbranched) unsubstituted alkyl group. An “alkylene” group is a divalent moiety derived from the corresponding alkyl group. The terms “alkenyl” and “alkynyl” refer to unsaturated aliphatic groups analogous to alkyls, but which contain at least one double or triple carbon-carbon bond respectively. Suitable alkenyl and alkynyl groups include groups having 2 to about 12 carbon atoms, preferably from 1 to about 6 carbon atoms. A “vinyl” group is an ethylenyl group (i.e., —CH═CH₂). A “styryl” group is a vinyl-phenyl group.

The term “aromatic group” includes unsaturated cyclic hydrocarbons containing one or more rings. Aryl groups may also be fused or bridged with alicyclic or heterocyclic rings which are not aromatic so as to form a polycycle (e.g., tetralin). The term “aromatic group” includes unsaturated cyclic hydrocarbons containing one or more rings. In general, the term “aryl” includes groups, including 5- and 6-membered single-ring aromatic groups that may include from zero to four heteroatoms, for example, groups derived from benzene, pyrrole, furan, thiophene, thiazole, isothiaozole, imidazole, triazole, tetrazole, pyrazole, oxazole, isooxazole, pyridine, pyrazine, pyridazine, and pyrimidine, and the like. An “arylene” group is a divalent moiety derived from an aryl group. The term “heterocyclic group” includes closed ring structures in which one or more of the atoms in the ring is an element other than carbon, for example, nitrogen, sulfur, or oxygen. Heterocyclic groups may be saturated or unsaturated and heterocyclic groups such as pyrrole and furan may have aromatic character. They include fused ring structures such as quinoline and isoquinoline. Other examples of heterocyclic groups include pyridine and purine. Heterocyclic groups may also be substituted at one or more constituent atoms.

The term “amino,” as used herein, refers to an unsubstituted or substituted moiety of the formula —NR^{a}R^{b}, in which R^{a} and R^{b} are each independently hydrogen, alkyl, aryl, or heterocyclyl, or R^{a} and R^{b}, taken together with the nitrogen atom to which they are attached, form a cyclic moiety having from 3 to 8 atoms in the ring. Thus, the term “amino” includes cyclic amino moieties such as piperidinyl or pyrrolidinyl groups, unless otherwise stated. Thus, the term “alkylamino” as used herein means an alkyl group, as defined above, having an amino group attached thereto. Suitable alkylamino groups include groups having 1 to about 12 carbon atoms, preferably from 1 to about 6 carbon atoms. The term “alkylthio” refers to an alkyl group, as defined above, having a sulfhydryl group attached thereto. Suitable alkylthio groups include groups having 1 to about 12 carbon atoms, preferably from 1 to about 6 carbon atoms. The term “alkylcarboxyl” as used herein means an alkyl group, as defined above, having a carboxyl group attached thereto. The term “alkoxy” as used herein means an alkyl group, as defined above, having an oxygen atom attached thereto. Representative alkoxy groups include groups having 1 to about 12 carbon atoms, preferably 1 to about 6 carbon atoms, e.g., methoxy, ethoxy, propoxy, tert-butoxy and the like. The term “nitro” means —NO₂; the term “halogen” or “halo” designates —F, —Cl, —Br or —I; the term “thiol,” “thio,” or “mercapto” means SH; and the term “hydroxyl” or “hydroxyl” means —OH.

Unless otherwise specified, the chemical moieties of the compounds of the invention, including those groups discussed above, may be “substituted or unsubstituted.” In some embodiments, the term “substituted” means that the moiety has substituents placed on the moiety other than hydrogen (i.e., in most cases, replacing a hydrogen) which allow the molecule to perform its intended function Examples of substituents include moieties selected from straight or branched alkyl (preferably C₁-C₅), cycloalkyl (preferably C₃-C₈), alkoxy (preferably C₁-C₆), thioalkyl (preferably C₁-C₆), alkenyl (preferably C₂-C₆), alkynyl (preferably C₂-C₆), heterocyclic, carbocyclic, aryl (e.g., phenyl), aryloxy (e.g., phenoxy), aralkyl (e.g., benzyl), aryloxyalkyl (e.g., phenyloxyalkyl), arylacetamidoyl, alkylaryl, heteroaralkyl alkylcarbonyl and arylcarbonyl or other such acyl group, heteroarylcarbonyl, or heteroaryl group, (CR′R″)₀₋₃NR′R″ (e.g., —NH₂), (CR′R″)₀₋₃CN (e.g., —CN), —NO₂, halogen (e.g., —F, —Cl, —Br, or —I), (CR′R″)₀₋₃C(halogen)₃ (e.g., —CF₃), (CR′R″)₀₋₃CH(halogen)₂, (CR′R″)₀₋₃ CH₂(halogen), (CR′R″)₀₋₃CONR′R″, (CR′R″)₀₋₃(CNH)NR′R″, (CR′R″)₀₋₃S(O)₁₋₂NR′R″, (CR′R″)₀₋₃CHO, (CR′R″)₀₋₃O(CR′R″)₀₋₃H, (CR′R″)₀₋₃S(O)₀₋₃R′ (e.g., —SO₃H), (CR′R″)₀₋₃O(CR′R″)₀₋₃H (e.g. —CH₂OCH₃ and —OCH₃), (CR′R″)₀₋₃S(CR′R″)₀₋₃H (e.g., —SH and —SCH₃), (CR′R″>₃OH (e.g., —OH), (CR′R″)₀₋₃COR′, (CR′R″)₀₋₃(substituted or unsubstituted phenyl), (CR′R″)₀₋₃(C₃-C₈ cycloalkyl), (CR′R″)₀₋₃CO₂R′ (e.g., —CO₂H), or (CR′R″)₀₋₃OR′group, or the side chain of any naturally occurring amino acid; wherein R′ and R″ are each independently hydrogen, a C₁-C₅ alkyl, C₂-C₅ alkenyl, C₂-C₅ alkynyl, or aryl group, or R′ and R″ taken together are a benzylidene group or a —(CH₂)₂O(CH₂)₂— group.

A “substituent” as used herein may also be, for example, halogen, hydroxyl, alkylcarbonyloxy, arylcarbonyloxy, alkoxycarbonyloxy, aryloxycarbonyloxy, carboxylate, alkylcarbonyl, alkoxycarbonyl, aminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), amidino, imino, sulfhydryl, alkylthio, arylthio, thiocarboxylate, sulfate, sulfonato, sulfamoyl, sulfonamido, nitro, trifluoromethyl, cyano, azido, heterocyclyl, aralkyl, or an aromatic or heteroaromatic moiety.

The present invention provides improved chromatography and extraction devices. In the devices of the invention, a portion of the column or cartridge is packed with a particulate stationary phase material (e.g., bonded silica particles having a diameter of about 1 to 3 μm). The term “column” as used herein may refer to the solid cylindrical container, e.g., a hollow fused silica capillary, or the term may refer to the packed bed of stationary phase material within the cylindrical container, or the term may refer to both aspects. Furthermore, unless otherwise specified, a column may refer to a column as typically used in analytical chromatography (e.g., an BPLC column) or a cartridge as commonly used in SPE.

An HPLC column may be fabricated from a variety of materials, such as those commonly employed in the manufacture of HPLC columns. In one particular embodiment, a stainless steel column is used. The dimensions of the packed column (length and inner diameter) may be similar to those commonly employed in the art, such dimensions depending on the specific intended use of the column. For example, the inner diameter of the stainless steel column may be 2.1 mm. A determination of the appropriate dimensions for a particular application is within the artisan's scope of routine experimentation.

An SPE device may be column or cartridge similar to those commonly employed in the art. For example, a cartridge may be made of polypropylene, or any other moldable, relatively firm, and unreactive polymer. Inexpensive polymers are preferred so that the resulting SPE device may be disposable. A typical SPE column used in the invention has a cylindrical interior for accepting a stationary phase. Packed columns of the invention may be of a variety of lengths, sizes, and formats depending on the intended application.

An exemplary chromatography device of the invention therefore includes a column, e.g., packed with an immobilized particulate stationary phase material and an optional solid support. The solid support may be a frit is adjacent to the stationary phase material at, e.g., the ends of an HPLC column.

A wide variety of particulate stationary phase materials may be used in the invention. Accordingly, the immobilized particulate stationary phase or packing of a chromatography devices of the invention is made from a “particulate stationary phase material” or “particles of a stationary phase material.” Furthermore, as discussed above the immobilized stationary phase retains a particulate nature, as opposed to being a monolith material.

By way of example, the particles of the stationary phase material may have an average size/diameter of about 0.5 μm to about 10.0 μm, or more particularly about 3 μm to about 5.0 μm. In certain circumstances, particle size distribution should be within 10% of the mean. Typically, the stationary phase material is porous, although it may also be non-porous. Additionally, the stationary phase material may have an average pore deter of about 70 Å to about 300 Å; or a specific surface area of about 50 m²/g to about 250 m²/g; or a specific pore volume of about 0.2 to 1.5 cm³/g. Although it should be noted that chemical modification of the adsorbent surface may have an influence on the surface area and the pore volume of the stationary phase material. This effect is significant in the case of, e.g., bonded silica, which may have surface area of 350 m²/g reduced to 170 m²/g after bonding with octadecyisilane.

Generally, it will be preferable to use spherically shaped particles rather than irregularly shaped particles. It is well known in the art that irregularly-shaped materials are often more difficult to pack than spherical materials. It is also known that spherical materials are easier to pack and exhibit greater packed bed stability than columns packed with irregularly-shaped materials of the same size. Exemplary particles include Xterra® and Oasis HLB®, commercially available from Waters Corporation (Milford, Mass., USA). Oasis HLB is particularly preferred.

In general, any particulate stationary phase material known in the art for use in HPLC columns may also be used in the chromatography devices of the present intention Examples of suitable particulate stationary phase materials for use include alumina, silica, titanium oxide, zirconium oxide, a ceramic material, an organic polymer, or a mixture thereof. Preferred stationary phase materials have been bonded with a surface modifier. Such surface modifiers may be an alkyl group, alkenyl group, alkynyl group, aryl group, cyano group, amino group, diol group, nitro group, ester group, or an alkyl or aryl group containing an embedded polar functionality. For example, an alkyl group surface modifier group may be a methyl, ethyl, propyl isopropyl, butyl, tert-butyl sec-butyl pentyl, isopentyl, hexyl, cyclohexyl, octyl or octadecyl group. Further examples of fitting particulate stationary phase materials include alkyl-bonded, phenyl-bonded, cyano-bonded, diol-bonded, and amino-bonded silica, and mixtures thereof. Suitable materials are readily available from a variety of commercial sources, including Waters Corporation (Milford, Mass., USA), Alltech Associates, Inc. (Deerfield, Ill., USA), Beckman Instruments, Inc. (Fullerton, Calif., USA), Gilson, Inc. (Middleton, Wis., USA), EM Science (Gibbstown, N.J., USA), Supelco, Inc. (Bellefonte, Pa., USA).

An immobilized stationary phase of the invention may be a mixture of the stationary phase material and a polymeric network of cross-linked poly(diorganosiloxane), e.g., poly(dimethylsiloxane). In general, an immobilized stationary phase of the invention may be made my placing a mixture of a stationary phase material, a solvent, and polymer reagents into a column (having a cylindrical interior for accepting the stationary phase). The polymer reagents are compounds that produce cross-linked poly(diorganosiloxane) after “curing.” The mixture in the column is maintained at room temperature or warmer in order remove solvent by evaporation. The column may then be further heated to promote curing.

The resulting material within the column is a suspension of discrete particles, which may be visually identified by microscopy, in a polymeric network. As the poly(diorganosiloxane) cures, it reacts with itself and the other polymer reagents to form cross-links which all together form a network or matrix throughout the particulate stationary phase material. Such a mixture is therefore an “intimate” homogenous mixture, as opposed to a simple mixture of two separate components having no interaction with each other. As such, the product is an immobilized stationary phase, rather than a monolith.

The poly(diorganosiloxane) polymers used in the present invention typically include those formed from precursors including the chlorosilanes such as methylchlorosilanes, ethylchlorosilanes, and phenylchlorosilanes, and the like. The poly(diorganosiloxane) polymers may also be cross-linked when a branched polymerizable monomer is included in the polymer and subsequently reacted. The polymer reagents used in the instant invention may themselves also be polymers. A particularly preferred polymer is poly(dimethylsiloxane) (“PDMS”). See, e.g. U.S. Pat. Nos. 4,374,967, 4,529,789, 4,831,070, 4,882,377, 6,169,155, and 5,571,853.

Although the polymers described herein are referred to as “poly(dimethylsiloxane),” etc., one skilled in the art will appreciate that such polymers may contain amounts of other units, including, e.g., monomethylsiloxane and other mono- or diorganosiloxane units, which are often formed during synthesis of the polymer, so long as these units do not substantially alter the properties.

The poly(diorganosiloxane) of the invention may be a polymer having a repeat unit of the formula —(—R¹R²SiO—)—, wherein R¹ and R² are independently hydrogen, a C₁-C₁₈ aliphatic group, an aromatic group, or a cross-linking group. Alternatively, the poly(diorganosiloxane) may be a polymer having the formula (—R¹R²SiO—)ₙ, wherein R¹ and R² are independently hydrogen, a C₁-C₁₈ aliphatic group, an aromatic group, or a cross-linking group, and n represents the number of repeat units. For example, R¹ and R² may each be a straight or branched-chain alkyl or cycloalkyl group, such as a C₁-C₆ alkyl group, including methyl, ethyl, n-propyl isopropyl, butyl, sec-butyl and tert-butyl groups.

Cross-linked PDMS (or “siloxane”) may be made from a variety of “polymer reagents,” for example, a polyorganosiloxane that is cured with an organohydrogensiloxane cross-linking reagent. As used herein, the term “cross-linking” group is a hydrocarbon group containing a polymerizable alkenyl group, although the term “cross-linking group” may also refer to the product of the polymerization of such a group. Examples of cross-linking groups include a vinyl group or a styryl group. For example, in the presence of a suitable catalyst (e.g., a platinum compound), a vinyl group of a cross-linkable polymer reagent may react with another polymer reagent (e.g., an organohyrogensiloxane) containing an Si—H bond to thereby cross-link the material. The polymer reagents used in the invention may also include a poly(dimethylsiloxane) that does not have cross-linkable groups. These “non-functional” polymers do not substantially undergo a cross-linking reaction, and examples include polymers of the general formula HO[Si(CH₃)₂O]ₘH, where m has an average value of about 50 to about 1000.

Generally, one of the polymer reagents used in the invention contains a vinyl group on a polyorganosiloxane, which will react with a suitable cross-linker. A suitable cross-linker is an organohydrogensiloxane having a Si—H bond, generally with an average of more than one Si—H bond per molecule and no more than one Si—H bond per silicon atom. The other substituents on the silicon atom may be, e.g., lower alkyl groups. An example of an organohydrogensiloxane compound which may be employed in the practice of the present invention is 1,3,5,7-tetramethylcyclotetrasiloxane (or tetramethyl tetravinyl cyclotetrasiloxane). Another cross-linker is a dimethylhydrogensiloxane-terminated polydimethylsiloxane, HMe₂Si(OMe₂Si)ₓH. Further examples of cross-linking polymer reagents comprise a polymer of dimethylsiloxane units, methylhydrogensiloxane units, and trimethylsiloxane units.

Accordingly, the polymer reagents used in the invention typically comprise at least four components: (1) an organopolysiloxane containing a silicon-bonded alkenyl group, (2) a non-functional organopolysiloxane, (3) an organohydrogenpolysiloxane, and (4) a catalyst.

In one aspect of the invention, the poly(diorganosiloxane) is selected from poly(dimethylsiloxane) polymers. Likewise, the cross-linked poly(diorganosiloxane) is selected from the group consisting of cross-linked poly(dimethylsiloxane) polymers.

For example, a cross-linkable polymer reagent may contain an average of at least two silicon-bonded alkenyl groups per molecule. Suitable alkenyl groups contain from 2 to about 6 carbon atoms, such as vinyl, allyl, butenyl (e.g., 1-butenyl), and hexenyl (e.g., 1-hexenyl) groups. The alkenyl groups may be located at terminal pendant (non-terminal), or both terminal and pendant positions. The remaining silicon-bonded organic groups may be monovalent hydrocarbon and monovalent halogenated hydrocarbon groups free of aliphatic unsaturation (e.g., alkyl groups, particularly lower alkyl groups, such as methyl, ethyl, propyl, and butyl) as well as aryl groups such as phenyl; and halogenated alkyl groups such as 3,3,3-trifluoropropyl. A cross-linkable polymer reagent may be linear, or it may contain branching because of trifuctional siloxane units. Examples of poly(diorganosiloxane) reagents may have the general formula R⁴R³₂SiO(R³₂SiO)ₙSiR³₂R⁴ wherein each R³ is independently an alkyl group or halogenated hydrocarbon groups free of aliphatic unsaturation (e.g., alkyl or aryl group); R⁴ is an alkenyl group; and n has a value such that the viscosity is convenient. Typically, n is from about 200 to about 600. Preferably, R³ is methyl and R⁴ is vinyl.

For example, a cross-linkable polymer reagents, particularly poly(diorganosiloxane) compounds, useful in the invention include the following:
(H₂C═CH)Me₂SiO(Me₂SiO)ₙSiMe₂(CH═CH₂)
(H₂C═CH)Me₂SiO(Me₂SiO)ₓ(MePhSiO)_{y}SiMe₂(CH═CH₂),
(H₂C═CH)Me₂SiO(Me₂SiO)ₓ(Me(CH═CH₂)SiO)_{y}SiMe₂(CH—CH₂),
(H₂C═CH)MePhSiO(Me(CH═CH₂)SiO)ₓ(MePhSiO)_{y}SiMePh(CH═CH₂),
Me₃SiO(Me₂SiO)ₓ(Me(CH═CH₂)SiO)_{y}SiMe₃,
PhMe(H₂C═CH)SiO(Me₂SiO)ₙSiPhMe(CH═CH₂),
and so on, where x+y=n, and n is about 100 to 1000. Preferred poly(diorganosiloxane) polymer reagents include dimethylvinylsiloxy-terminated polydimethylsiloxanes.

Examples of organohydrogensiloxane polymer reagents include having the formula R⁷Si(OSiR⁸₂H)₃ wherein R⁷ is a branched or unbranched alkyl group having 1 to 18 carbon atoms or an aryl group, and R⁸ is a branched or unbranched alkyl group having 1 to 4 carbon atoms. Examples of suitable R7 groups include methyl, ethyl, n-propyl, isopropyl butyl 2-methylpropyl,-pentyl, 2-methylbutyl, 2,2-dimethylpropyl, hexyl, 2-methylpentyl, 3-methylpentyl, 2,2-dimethybutyl, 2,3 dimethylbutyl, heptyl, 2-methyhexyl, 3-methylhexyl, 2,2-dimethylpentyl, 2,3-dimethylpentyl, 2,4-dimethylpentyl, 3,3-dimethylpentyl, 3-ethylpentyl, 2,2,3-trimethylbutyl, octyl, nonyl, decyl undecyl, dodecyl, tridecyl, tetradecyl, pentadecyl, hexadecyl heptadecyl, and octadecyl, phenyl, tolyl, and benzyl. Preferably R⁷ is n-propyl. Examples of suitable R⁸ groups include methyl, ethyl, propyl, n-butyl and 2-methylpropyl.

In general, the dimethyl siloxane or methylhydrogen siloxane may have an average molecular weight of about 10 Da to about 10,000, or more particularly average molecular weight of about 100 Da to about 1,000. Similarly, the vinyl-substituted dimethyl siloxane may have an average molecular weight of about 500 Da to about 100,000 Da, or more particularly an average molecular weight of about 10,000 Da to about 40,000 Da

The polymer reagents are reacted, i.e., cross-linked or “cured,” in situ by heating. In one embodiment, the curing step comprises heating the mixture to a temperature of between about 25° C. and about 150° C. for a period of time ranging from about 1 hour to about 48 hours.

The curing step may be facilitated by addition of a small amount of a platinum hydrosilation catalyst, e.g., a platinum catalyst that catalyzes the reaction between silicon-bonded hydrogen and vinyl groups. More generally, the hydrosilylation catalyst may be any active transition metal catalyst as known in the art, particularly those comprising rhodium, ruthenium, palladium, osmium, or iridium, in addition to platinum. Suitable catalysts include chloroplatinic acid catalyst, U.S. Pat. No. 2,823,218, and the reaction products of chloroplatinic acid and an organosilicon compound, see, e.g., U.S. Pat. No. 3,419,593. Also applicable are the platinum hydrocarbon complexes described in U.S. Pat. Nos. 3,159,601 and 3,159,662, and the platinum acetyl acetonate shown in U.S. Pat. No. 3,723,497, and the platinum alcoholate catalysts described in U.S. Pat. No. 3,220,972. For any of the particular platinum catalysts selected, the practitioner will be able to determine an optimum catalytically effective amount to promote curing. Platinum catalysts have been used effectively in amounts sufficient to provide from about 0.1 to 40 parts by weight of platinum per million parts by weight of total formulation.

The catalyst may be any catalyst that may promote the addition reaction between an alkenyl group and a Si—H group. The platinum group metal catalysts include, for example, chloroplatinic acid, alcohol-modified chloroplatinic acids, coordination compounds of chloroplatinic acid with an olefin, vinylsiloxane or acetylene compound, tetrakis-(triphenylphosphine)palladium, chlorotris(triphenylphosphine)rhodium and the like, among which particularly preferred are platinum compounds.

In the composition of the present invention, the catalyst is normally present in an amount of from 0.1 to 100 ppm based on the total amount of the other components although a determination of the appropriate amount for a particular situation will be within the scope of routine experimentation typically undertaken by the skilled practitioner.

The poly(diorganosiloxane) polymers used in the present invention typically include those formed from precursors including the chlorosilanes such as methylchlorosilanes, ethylchlorosilanes, and phenylchlorosilanes, and the like. The poly(diorganosiloxane) polymers may also be cross-linked when a branched polymerizable monomer is included in the polymer and subsequently reacted.

A variety of known additives may be included in the polymer reagents. For example, inorganic fillers such as fumed silica, silica aerogel precipitates silica, ground silica, and the like may be added in order to modulate the physical properties of the polymeric network, e.g., hardness, mechanical strength, etc. Certain controlling agents such as cyclic polymethylvinyisiloxane compounds, acetylene compounds, organophosphorus compounds, and the like may be added to the composition, thereby controlling the rate of the curing reaction. Although such additives may be added to impart additional desirable features, additives preferably do not substantially reduce the chromatographic efficiency or usefulness of the resulting materials.

Therefore, in yet another example, the cross-linked poly(diorganosiloxane) polymers of the invention may be made from polymer reagents contributing the following exemplary units: One unit may be primarily comprised of dimethylsiloxane (Me₂SiO) repeat units, which may be 80 to 96.5 mol % of the total siloxane units in the polymer. A second unit of the polyorgano-siloxane may be monomethylsiloxane (MeSiO_{1.5}), which may be 2 to 10.0 mol % of the total siloxane units in the polymer. The MeSiO_{1.5} group imparts a higher melting temperature than without monomethylsiloxane units (a polymer chain only of dimethylsiloxane units would crystallize at approximately −40° C., whereas monomethylsiloxane units randomly placed along the siloxane polymer chain avoids the crystalline phase). A third unit may be the trimethyl-siloxane unit (Me₃SiO_{0.5}), which functions as an endblocker for the polymer chain, and may be 1.25 to 6.0 mol % of the total organosiloxane. A final unit in the siloxane polymer may be a vinyl-containing siloxane unit, e.g., dimethylvinylsiloxane (Me₂(H₂C═CH)SiO_{0.5}), where the vinyl group is in a terminal position (a terminal vinyl group cures more quickly than an internal vinyl group (i.e., Me(H₂C═CH)SiO)). The terminal vinyl unit also functions as an endblocker in conjunction with the trimethylsiloxane units, and it may be 0.25 to 4 mol % of the total organosiloxane units in the polymer.

In another example, the cross-linked poly(diorganosiloxane) is produced by the reaction of a polymer reagent comprising vinyl-substituted dimethyl siloxane, such as dimethylvinyl-terminated dimethyl siloxane. Other specific examples of polymer reagents include dimethyl siloxane, methylhydrogen siloxane, dimethylvinylated silica, trimethylated silica, tetramethyl tetravinyl cyclotetrasiloxane, and tetra(trimethylsiloxy) silane.

Exemplary poly(dimethylsiloxane) polymers include those sold under the tradename Sylgard by the Dow Corning Corporation (Midland, Mich., USA). The PDMS polymer may easily be produced by mixing the precursor and the catalyst of a commercially available Sylgard kit in an appropriate ratio followed by curing. Sylgard poly(dimethylsiloxane) polymers may be readily synthesised by curing a mixture of A and B components, where A is, e.g., dimethylvinyl terminated polydimethyl siloxane and B is, e.g., trimethyl terminated siloxane with partially hydrogen-substituted methyl side groups. Polymers having various properties may be synthesized simply by varying the weight ratio of A to B, and the molecular weight and functionality of the A and B kit components. For example, in the product known by the tradename Dow Sylgard 527, the average molecular weight distribution of both A and B components is broad and centers around 20,000 grams/mole, and the functionality of the B component is about 102.

Generally, a Sylgard kit allows facile synthesis of PDMS polymer. Sylgard poly(dimethylsiloxane) polymers may be readily synthesized by curing a mixture of A and B components, where A is, e.g., dimethylvinyl terminated polydimethyl siloxane and B is, e.g., trimethyl terminated siloxane with partially hydrogen-substituted methyl side groups. Polymers having various properties may be synthesized simply by varying the weight ratio of A to B, and the molecular weight and functionality of the A and B kit components.

More generally, poly(diorganosiloxane) polymers of the present invention may be prepared from a vinyl endblocked poly(diorganosiloxane), e.g., poly(dimethylsiloxane), component “A”, and another organosiloxane, component “B”, optionally with a catalyst. Different polymers may be similarly synthesized by varying the compositions of A and B, as well as the relative amounts of the A and B components. The triorganosiloxy endblocked poly(dimethylsiloxane) is referred to as “A.” The triorganosiloxy group may contain a vinyl radical and two methyl radicals bonded to silicon or a vinyl, a phenyl, and a methyl radical bonded to silicon. For examples, A may have the following chemical structure:
(CH₂═CH)(CH₃)₂Si—(OSi(CH₃)₂)ₙO—Si(CH₃)₂(CH═CH₂).

Component A may be any triorganosiloxy endblocked poly(dimethylsiloxane) that exhibits a suitable chromatographic properties in the chromatographic columns and methods of the invention. The dispersity index value takes into account the concentration of all polymeric species present in A, and is obtained by dividing the weight average molecular weight of a given polymer by its number average molecular weight. Two or more poly(dimethylsiloxane) polymers of different molecular weights may be mixed to achieve a different dispersity index and molecular weight distribution. Another method of preparing preferred embodiments of A is described, e.g., in U.S. Pat. No. 3,445,426. Preferably, the triorganosiloxy endblocking group of A is a dimethylvinylsiloxy group.

The organosiloxane copolymer “B” may be a trimethyl terminated siloxane with partially hydrogen-substituted methyl side groups. These polymers may contain units of the formulae (CH₃)₂(CH₂═CH)SiO_{1/2}, (CH₃)₃SiO_{1/2}, and SiO₂. U.S. Pat. No. 2,676,182. These copolymers contain certain percentages by weight of hydroxyl groups, which may changed by altering the concentration of triorganosiloxane capping agent. For example, a silica hydrosol may be reacted with hexamethyldisiloxane or trimethylchlorosilane under acidic conditions, followed by reaction with silazane, siloxane, or silane containing a vinyl and two methyl radicals bonded to silicon.

The A and B components react in the presence of a suitable catalyst to yield an elastomeric gel. A preferred class of catalysts includes the platinum compositions that are known to catalyze the reaction between silicon-bonded hydrogen atoms and olefinic double bonds, particularly silicon-bonded vinyl groups, and that are soluble in A. A particularly suitable class of platinum-containing catalysts are the complexes prepared from chloroplatinic acid and certain unsaturated organosilicon compounds and described in U.S. Pat. No. 3,419,593. The platinum catalyst may be present in an amount sufficient to provide at least one part by weight of platinum for every one million parts by weight of A, however it is preferable to use as little catalyst as possible. Mixtures containing components A and B with a platinum catalyst may begin to cure immediately on mixing at room temperature, and therefore it may be preferable to use a catalyst inhibitor, such as those inhibitors described in U.S. Pat. No. 3,445,420, including inhibitors such as acetylenic alcohols, particularly 2-methyl-3-butyn-2-ol. Once the curing reaction commences, however, it proceeds at the same rate as if no inhibitor were present. Inhibited compositions are typically cured by heating them to a temperature of about 70° C. or higher. If a catalyst is used, particularly catalysts such as platinum catalysts that are active at very low concentrations, then care must be taken to completely remove all traces of catalyst from the ultimate chromatography column. Residual catalyst may lead to the catalysis of reactions with of analytical compounds as they pass through a contaminated stationary phase material in a chromatography column, and therefore compromise the usefulness of the material. In the case of Sylgard 184, the manufacturer recommends that it be cured using for 24 hours at 23° C., or 4 hours at 65° C., or 1 hour at 100° C., or 15 minutes at 150° C.; although large amounts may require longer times in order to reach the curing temperature. At 23° C. the material will have cured sufficiently in 24 hours to be handled; however full mechanical and electrical properties will only be fully achieved after 7 days.

Accordingly, the present invention is directed to an immobilized stationary phase in a chromatography column comprising an intimate mixture of particles of a stationary phase material and a polymeric network comprising cross-linked poly(diorganosiloxane), wherein the particles are suspended in the network. Such immobilized stationary phases may be used in, e.g., HPLC columns or in SPE devices.

In order to maximize the usefulness of such column chromatography devices, the relative amount of the polymer component to the stationary phase material should be sufficiently high to satisfactorily immobilize the stationary phase. On the other hand, the relative amount of polymer component should low enough that it does not substantially alter the chromatographic partitioning properties of the stationary phase material itself. Indeed, if the relative amount of the polymeric component is too high, then the resulting back pressure may be impracticably high and preclude a chromatographically-useful flow rate. Although the optimal relative amount of polymer to stationary phase material will depend on the precise circumstances, one skilled in the art will be able to ascertain with no more than routine experimentation an appropriate composition in accord with the objects of the present invention. By way of example, the intimate mixture of particles (of stationary phase material) and a polymeric network (of cross-linked poly(diorganosiloxane)) as described herein may be approximately a 10:1 (w/w) composition, or a 15:1 (w/w) composition, or even a 20:1 (w/w) composition, or even a 25:1 (w/w) composition. In some cases, the intimate mixture may even be approximately a 50:1 (w/w) composition of particles to polymeric network, or even a 70:1 (w/w) composition, or a 100:1 (w/w) composition, or even a 1000:1 (w/w) composition. Such relative amounts may be achieved by calculating or estimating the stoicheometric equivalents of each reagent or component that is to be included in the manufacture of the materials. Likewise, such ratios may be determined by post facto empirical analysis of the resulting products, e.g., by combustion analysis or other such methods.

Likewise, the invention relates to a medium for molecular separations comprising an intimate mixture of particles of a stationary phase material and a polymeric network of cross-linked poly(diorganosiloxane), where the particles are suspended in the network.

In a further embodiment, the invention relates to a column chromatography device comprising a column having a cylindrical interior for accepting a stationary phase, a particulate stationary phase material packed within the column. The stationary phase material is immobilized, and it comprises an intimate mixture of particles of a stationary phase material and a polymeric network of cross-linked poly(diorganosiloxane), where the particles are suspended in the network.

The invention also pertains to a separations instrument comprising a column chromatography device and at least one component selected from a detecting means, an introducing means, or an accepting means. One skilled in the art will appreciate that a variety of detecting means, introducing means, and accepting means may be used according to the invention in analogous manner as the equivalent or even identical equipment is used in, e.g., HPLC and other common analytical chromatography methods. The column chromatography device may comprise a column having a cylindrical interior for accepting a stationary phase and a particulate stationary phase material packed within the column that has been immobilized within the column. The immobilized stationary phase comprises an intimate mixture of particles of a stationary phase material and a polymeric network of cross-linked poly(diorganosiloxane), where the particles of stationary phase material suspended in the network. The accepting means is capable of holding the column in a configuration in which the column is operatively connected to either a detecting means or an introducing means.

The detecting means is operatively connected to the column and is capable of measuring physicochemical properties (light absorption/emission, conductivity, etc.), and examples include detectors such as those commonly used as HPLC detectors. Such detectors measure, e.g., refractive index, UV/Vis absorption or emission (at a fixed wavelength or variable wavelength), fluorescence (e.g., with a laser source), conductivity, molecular mass (by mass-spectrometry), and evaporative light scattering. Optical detectors are used frequently in liquid chromatographic systems. In these systems, the detector passes a beam of light through the flowing column effluent as it passes through a low volume flowcell. The variations in light intensity caused by UV absorption, fluorescence emission, or change in refractive index (depending on the type of detector used) from the sample components passing through the cell, are monitored as changes in the output voltage. These voltage changes are recorded on a strip chart recorder and frequently are fed into an integrator or computer to provide retention time and peak area data. A commonly used detector is an ultraviolet absorption detector. A variable wavelength detector of this type operates at about 190 nm to about 460 nm (or even about 600 nm).

The introducing means is operatively connected to the column and is capable of conducting a liquid into the column. Injectors and pumps are the most common introducing means used in liquid chromatography. A simplest method of sample introduction is to use an injection valve, although automatic sampling devices may be incorporated where sample introduction is done with the help of autosamplers and microprocessors. In liquid chromatography, liquid samples may be injected directly and solid samples need only be dissolved in an appropriate solvent. The solvent need not be the mobile phase, but frequently it is chosen to avoid detector, column, or component interference. Injectors for liquid chromatographic systems should provide the possibility of injecting a small volume liquid sample with high reproducibility and under high pressure. They should also produce minimum band broadening and minimize possible flow disturbances. An example of a sampling device is the microsampling injector valve. Because of their superior characteristics, valves such as the Rheodyne injector are very common, because these devices allow samples to be introduced reproducibly into pressurized columns without significant interruption of flow, even at elevated temperatures, and with injection volumes as small as 60 nL.

Examples of pumping means include high pressure pumps that are able to force solvents through packed stationary phase beds. Smaller bed particles are narrower bore columns require higher pressures. Ideally, such pumps have electronic feedback systems and multi-headed configurations that allow the pump to maintain a constant pressure. It is desirable to have an integrated degassing system, either helium purging, or better vacuum degassing.

Furthermore, the invention relates to a chromatography device prepared by the steps of providing a column having a cylindrical interior for accepting a stationary phase, and forming an immobilized stationary phase within the column. The immobilized stationary phase of the invention comprises a an intimate mixture of particles of a stationary phase material and a polymeric network of cross-linked poly(diorganosiloxane), where the particles are suspended in the network.

Methods of HPLC column packing are generally known in the art, and depend principally on the mechanical strength of the packing, its particle size and particle size distribution, and the diameter of the column to be packed. Conventional column packing methods, such as dry packing, typically used for particles greater than about 20 μm in diameter, are not useful for small capillary columns that typically have diameters in the range of tens of microns. For particles between 1 and 20 μm in diameter slurry techniques may be used. In slurry packing the particles that form the bed are suspended as a slurry in an appropriate liquid or liquid mixture. Many liquids or liquid mixtures may be used to prepare the slurry, the principal requirement being that the liquid thoroughly wet the packing particles and provide adequate dispersion of the packing material. The slurry is then pumped into the column under high pressure optionally with mechanical agitation, e.g., sonication.

Accordingly, the invention relates to a method of making a chromatography device comprising the steps of

a) providing a column having a cylindrical interior for accepting a stationary phase, and

b) forming an immobilized stationary phase within the column, wherein the immobilized stationary phase comprises an intimate mixture of particles of a stationary phase material and a polymeric network of cross-linked poly(diorganosiloxane), and wherein the particles are suspended in the network. The step of “forming an immobilized stationary phase stationary phase” may comprise the steps of

a) preparing a mixture of the stationary phase material, a solvent, and synthetic precursors of cross-linked poly(diorganosiloxane);

b) introducing the mixture prepared in step (a) into an the column;

c) allowing the solvent to evaporate at room temperature;

d) curing the dried mixture by heating the column and the mixture therein to a temperature of between about 70° C. to about 150° C. for a period of time ranging from about 0.5 hours to about 3 hours to thereby produce an immobilized stationary phase.

In one such embodiment, the chromatography device is an HPLC column or an SPE cartridge, tube, or filtering device.

Although the polymer may cross-link, i.e., “cure;” without any further intervention, the curing step may comprise an additional step of heating the mixture to a temperature of between about 20° C. to about 40° C. for a period of time ranging from about 5 hours to about 35 hours, followed directly by heating the mixture to a temperature of between about 70° C. to about 150° C. for a period of time ranging from about 0.5 hours to about 3 hours. Alternatively, the curing step may comprise heating the mixture to room temperature for a period of about one day, followed by heating the mixture to a temperature of about 110° C. for a period of time of about 2 hours. Another protocol entails letting the initial mixture stand at 25° C. for about 24 hours or heating the mixture at 40 to 150° C.

The present invention also relates to methods of using the chromatography devices and materials described herein. For example, the invention pertains to an analytical method of separating components of a mixture comprising a step of contacting the mixture with a column chromatography device of the invention. Similarly, the invention also covers a separations instrument comprising a column chromatography device of the invention. Additionally, the inventions discloses methods of analyzing components of a mixture comprising a step of contacting such a mixture with a column chromatography device of the invention, as well as methods of separating components of a mixture comprising a step of contacting such a mixture with a column chromatography device of the invention.

Furthermore, the instant application pertains to a separations instrument comprising a column chromatography device of the invention, such as a HPLC instrument. Such instruments may comprise a pumping means for moving liquid through the column chromatography device, and a detecting means for analyzing the column chromatography device effluent.

Those skilled in the art will recognize, or be able to ascertain using no more than routine experimentation, numerous equivalents to the specific procedures, embodiments, claims, and examples described herein. Such equivalents were considered to be within the scope of this invention and covered by the claims appended hereto. The contents of all references, issued patents, and published patent applications cited throughout this application are hereby incorporated by reference. The invention is further illustrated by the following example, which should not be construed as further limiting the invention.

### EXAMPLE

The inside of a blank SPE tip was first wetted with a solution of 5% poly(dimethylsiloxane) (PDMS Sylgard 184 kit) in ethyl acetate, and filled with 5 mg of 9 μm Oasis HLB stationary phase material (Waters Corporation, Milford, Mass.). Afterwards, 0.1 mL of 5% PDMS solution was passed through the bed by gravity. The solvent was allowed to evaporate for 1 hour at room temperature, and then the and the tip was placed in an oven heated to 110° C. for 1 hour. No frit was placed in the device to retain the stationary phase material. The device was inverted (open end downward) and no free stationary phase material was observed to escape.

### INCORPORATION BY REFERENCE

The entire contents of all patents, published patent applications and other references cited herein are hereby expressly incorporated herein in their entireties by reference.

Equivalents

Those skilled in the art will recognize, or be able to ascertain using no more than routine experimentation, numerous equivalents to the specific procedures described herein. Such equivalents were considered to be within the scope of this invention and are covered by the following claims. The contents of all references, issued patents, and published patent applications cited throughout this application are hereby incorporated by reference.

1. An immobilized stationary phase in a chromatography column comprising an intimate mixture of particles comprising a stationary phase material and a polymeric network comprising cross-linked poly(diorganosiloxane), wherein said particles are suspended in said network.

2. A medium for molecular separations or extractions comprising an intimate mixture of particles comprising a stationary phase material and a polymeric network comprising cross-linked poly(diorganosiloxane), and wherein said particles are suspended in said network.

3. A chromatography device comprising
a) a column having a cylindrical interior for accepting a stationary phase; and
b) an immobilized particulate stationary phase packed within said column;
wherein said immobilized stationary phase comprises an intimate mixture of particles comprising a stationary phase material and a polymeric network comprising cross-linked poly(diorganosiloxane), and wherein said particles are suspended in said network.

4. The chromatography device of claim 3 prepared by the steps of providing said column, and forming said immobilized particulate stationary phase within said column.

5. The chromatography device of claim 3, wherein said poly(diorganosiloxane) is a polymer having a repeat unit of the formula —(—R¹R²SiO—)—, wherein R¹ and R² are independently hydrogen, a C₁-C₁₈ aliphatic group, an aromatic group, or a cross-linking group.

6. The chromatography device of claim 3, wherein said poly(diorganosiloxane) is a polymer having the formula (—R¹R²SiO—)ₙ, wherein R¹ and R² are independently hydrogen, a C₁-C₁₈ aliphatic group, an aromatic group, or a cross-linking group, and n represents the number of repeat units.

7. The chromatography device of claim 6, wherein said cross-linking group is a hydrocarbon group containing a polymerizable alkenyl group or a polymerized product thereof.

8. The chromatography device of claim 7, wherein said cross-linking group is a vinyl group or a styryl group or a polymerized product thereof.

9. The chromatography device of claim 6, wherein said aliphatic group is a straight or branched-chain alkyl or cycloalkyl group.

10. The chromatography device of claim 9, wherein said aliphatic group is a C₁-C₆ alkyl group.

11. The chromatography device of claim 10, wherein said aliphatic group is a methyl, ethyl, n-propyl, isopropyl, butyl, sec-butyl, or tert-butyl group.

12. The chromatography device of claim 3, wherein said poly(diorganosiloxane) is selected from poly(dimethylsiloxane) polymers.

13. The chromatography device of claim 3, wherein said cross-linked poly(diorganosiloxane) is selected from the group consisting of cross-linked poly(dimethylsiloxane) polymers.

14. The chromatography device of claim 3, wherein said cross-linked poly(diorganosiloxane) is produced by the reaction of a polymer reagent comprising vinyl-substituted dimethyl siloxane.

15. The chromatography device of claim 14, wherein said vinyl-substituted dimethyl siloxane is dimethylvinyl-terminated dimethyl siloxane.

16. The chromatography device of claim 14, wherein said reaction further comprises a polymer reagent selected from the group consisting of dimethyl siloxane, methylhydrogen siloxane, dimethylvinylated silica, trimethylated silica, tetramethyl tetravinyl cyclotetrasiloxane, and tetra(trimethylsiloxy) silane.

17. The chromatography device of claim 16, wherein said dimethyl siloxane or methylhydrogen siloxane has an average molecular weight of about 10 Da to about 10,000.

18. The chromatography device of claim 17, wherein said dimethyl siloxane or methylhydrogen siloxane has an average molecular weight of about 100 Da to about 1,000.

19. The chromatography device of claim 14, wherein said vinyl-substituted dimethyl siloxane has an average molecular weight of about 500 Da to about 100,000 Da.

20. The chromatography device of claim 19, wherein said vinyl-substituted dimethyl siloxane has an average molecular weight of about 10,000 Da to about 40,000 Da.

21. The chromatography device of claim 3, wherein said mixture has been cured in situ by heating.

22. The chromatography device of claim 21, wherein said curing step comprises heating the mixture to a temperature of between about 25° C. and about 150° C. for a period of time ranging from about 1 hour to about 48 hours.

23. The chromatography device of claim 3, wherein the particles of said stationary phase material are approximately spherical.

24. The chromatography device of claim 3, wherein the particles of said stationary phase material have an average size/diameter of about 0.5 μm to about 10 μm.

25. The chromatography device of claim 3, wherein said stationary phase material is porous.

26. The chromatography device of claim 3, wherein said stationary phase material is non-porous.

27. The chromatography device of claim 3, wherein said stationary phase material has an average pore diameter of about 70 Å to about 300 Å.

28. The chromatography device of claim 3, wherein said stationary phase material has a specific surface area of about 170 m²/g to about 250 m²/g.

29. The chromatography device of claim 3, wherein said stationary phase material has a specific pore volumes of about 0.2 cm³/g to about 1.5 cm³/g.

30. The chromatography device of claim 3, wherein said particulate stationary phase material is alumina, silica, titanium oxide, zirconium oxide, a ceramic material, an organic polymer, or a mixture thereof.

31. The chromatography device of claim 3, wherein said stationary phase material has been bonded with a surface modifier.

32. The chromatography device of claim 31, wherein said surface modifier is selected from the group consisting of alkyl group, alkenyl group, alkynyl group, aryl group, cyano group, amino group, diol group, nitro group, ester group, or an alkyl or aryl group containing an embedded polar functionality.

33. The chromatography device of claim 32, wherein said alkyl group is selected from the group consisting methyl, ethyl, propyl, isopropyl, butyl, tert-butyl, sec-butyl, pentyl, isopentyl, hexyl, cyclohexyl, octyl, and octadecyl groups.

34. The chromatography device of claim 3, wherein said stationary phase material is alkyl-bonded, phenyl-bonded, cyano-bonded, diol-bonded, or amino-bonded silica, or a mixture thereof.

35. The chromatography device of claim 3, wherein said stationary phase material comprises porous inorganic/organic hybrid particles.

36. The chromatography device of claim 3, wherein said column is an HPLC column.

37. The chromatography device of claim 3, wherein the inner diameter of said column is about 1 to about 15 mm.

38. The chromatography device of claim 37, wherein said inner diameter is about 2.1 mm.

39. The chromatography device of claim 3, wherein said column is made of fused silica, glass, stainless steel, a polymer, a ceramic, or a mixture thereof.

40. The chromatography device of claim 3, wherein said column is less than about 33 cm or in length.

41. The chromatography device of claim 40, wherein said column is less than about 22 cm in length.

42. The chromatography device of claim 3, wherein said intimate mixture is a 10:1 (w/w) composition of particles of stationary phase material and a polymeric network of cross-linked poly(diorganosiloxane) in a ratio of about 10:1 to about 1000:1 stationary phase material to polymer by weight.

43. The chromatography device of claim 42, wherein said ratio is about 10:1 to about 100:1 stationary phase material to polymer by weight.

44. The chromatography device of claim 3, wherein said immobilized stationary phase is capable of physically withstanding a pressure of at least about 1,000 psi applied to a liquid flowing through the stationary phase.

45. The column chromatography device of claim 3, wherein said immobilized stationary phase frit has a tailing factor less than or equal to 2.3.

46. A method of making the chromatography device of claim 3 comprising the steps of
a) providing said column, a stationary phase material, and polymer reagents, and
b) forming said immobilized stationary phase within said column; said forming step comprising the steps of
i) placing said stationary phase material and said polymer reagents into said column; and
ii) curing the product of step (i) within said column to thereby produce an intimate mixture of particles comprising said stationary phase material and a polymeric network comprising cross-linked poly(diorganosiloxane), and wherein said particles are suspended in said network.

47. A method of making the chromatography device of claim 3 comprising the steps of
a) providing a mixture of a stationary phase material, a solvent, and polymer reagents that produce cross-linked poly(diorganosiloxane); and said column
b) introducing said mixture prepared in step (a) into said column;
c) allowing the solvent to evaporate at room temperature; and
d) curing the dried mixture by heating the column and the mixture therein to a temperature of between about 70° C. to about 150° C. for a period of time ranging from about 0.5 hours to about 3 hours to thereby produce an immobilized stationary phase consisting of an intimate mixture of particles comprising said stationary phase material and a polymeric network comprising cross-linked poly(diorganosiloxane), and wherein said particles are suspended in said network.

48. The method of claim 46, wherein said step of forming a stationary phase comprises the steps of
a) preparing a mixture of said stationary phase material, a solvent, and synthetic precursors of cross-linked poly(diorganosiloxane);
b) introducing said mixture prepared in step (a) into an end of said column;
c) allowing the solvent to evaporate at room temperature; and
d) curing the dried mixture by heating the column and the mixture therein to a temperature of between about 70° C. to about 150° C. for a period of time ranging from about 0.5 hours to about 3 hours to thereby produce an in situ frit.

49-94. (canceled)

95. A separations instrument comprising the chromatography device of claim 3 and at least one component selected from a detecting means, an introducing means, and an accepting means, wherein
said detecting means is operatively connected to said column and is capable of measuring physicochemical properties; and
said introducing means is operatively connected to said column and is capable of conducting a liquid into said column; and
said accepting means is capable of holding said column in a configuration in which the column is operatively connected to either a detecting means or an introducing means.

96. A separations instrument comprising the chromatography device of claim 3.

97-99. (canceled)

100. An analytical method of separating components of a mixture comprising the step of contacting said mixture with the chromatography device of claim 3.

101. A method of analyzing components of a mixture comprising a step of contacting said mixture with a chromatography device according to claim 3, wherein said chromatography device is an HPLC column.

102. A method of separating components of a mixture comprising a step of contacting said mixture with a chromatography device according to claim 3, wherein said chromatography device is an HPLC column.

103. A method of extracting components of a mixture comprising a step of contacting said mixture with a chromatography device according to claim 3, wherein said chromatography device is an SPE device.

104. A method of concentrating components of a mixture comprising a step of contacting said mixture with a chromatography device according to claim 3, wherein said chromatography device is an SPE device.

105. The chromatography device of claim 3 comprising a fritless column.

106. The chromatography device of claim 3 comprising a fritless column, prepared by the steps of
a) providing a column having a cylindrical interior for accepting a stationary phase;
b) placing a particulate stationary phase material into said column;
c) introducing polymer reagents into said stationary phase throughout said column to thereby form a mixture, wherein said polymer reagents are capable of forming a by cross-linking reactions a polymeric network of poly(diorganosiloxane); and
d) curing the mixture to thereby cross-link said poly(diorganosiloxane).

107. The chromatography device of claim 3 comprising a fritless column, prepared by the steps of
a) providing a column having a cylindrical interior for accepting a stationary phase;
b) placing a mixture of particulate stationary phase material and polymer reagents into said column, wherein said polymer reagents are capable of forming by cross-linking reactions a polymeric network of poly(diorganosiloxane); and
c) curing the mixture to thereby cross-link said poly(diorganosiloxane).

108. A method of making a packed HPLC column comprising the steps of
a) providing a stainless steel column having a cylindrical interior for accepting a stationary phase;
b) placing a mixture of particulate stationary phase material, a compatible solvent, and polymer reagents into said stainless steel wherein said polymer reagents are capable of forming by cross-linking reactions a polymeric network of poly(diorganosiloxane);
c) applying high pressure to compress or pack said mixture within said column; and
d) curing said mixture within said column while maintaining high pressure to cross-link said poly(diorganosiloxane) and thereby produce an immobilized stationary phase.

109. A solid phase extraction apparatus comprising a hollow body having an input port, an output port, and an immobilized a stationary phase located therein, wherein said immobilized stationary phase is an intimate mixture of particles comprising a stationary phase material and a polymeric network comprising cross-linked poly(diorganosiloxane), wherein said particles are suspended in said network.
